(19) United States
(12) Patent Application Publication
(10) Pub. No.: US 2023/0302571 A1
(43) Pub. Date: Sep. 28, 2023

(54) LASER PROCESSING SYSTEM

(71) Applicant: National Tsing Hua University, Hsinchu City (TW)

(72) Inventor: Hung-Wen Chen, Hsinchu City (TW)

(73) Assignee: National Tsing Hua University, Hsinchu City (TW)

(21) Appl. No.: 18/172,311

(22) Filed: Feb. 22, 2023

(30) Foreign Application Priority Data
Mar. 28, 2022 (TW) 111111574

(51) Int. Cl. B23K 26/06; B23K 26/064; B23K 26/067; B23K 1/005

(52) U.S. Cl. CPC B23K 26/0604; B23K 26/064; B23K 26/067; B23K 26/0626; B23K 1/0056

(57) ABSTRACT

A laser processing system configured to provide a processing beam is provided. The laser processing system includes a laser, a beam splitting module, a first adjustment module, and a second adjustment module. The laser is configured to provide a laser beam. The beam splitting module is configured to split the laser beam into a first laser beam and a second laser beam. The first adjustment module is disposed on a transmission path of the first laser beam and configured to adjust the first laser beam to a central portion of the processing beam. The second adjustment module is disposed on a transmission path of the second laser beam and configured to adjust the second laser beam to an outer ring portion of the processing beam.

### CROSS-REFERENCE TO RELATED APPLICATION

This application claims the priority benefit of Taiwan application serial no. 111111574, filed on Mar. 28, 2022. The entirety of the above-mentioned patent application is hereby incorporated by reference herein and made a part of this specification.

### BACKGROUND

### Technical Field

The disclosure relates to a processing system, and in particular to a laser processing system.

### Description of Related Art

Laser soldering technology is the use of laser instead of traditional reflow, wave soldering or soldering iron equipment, using a small and concentrated laser speckle to target a specific region for soldering processing. However, the laser speckle is distributed in the form of Gaussian beam for processing in the soldering region, and the Gaussian beam is continuously distributed, while there is a gap between the component and the pad in the soldering region, the residual laser light irradiated in the gap not only causes energy waste, but also may cause thermal damage to the component under the gap, which reduces the production yield. In addition, because the laser speckle cannot be adjusted to a specific region in terms of size or energy, the laser speckle cannot be used effectively, and the distribution of optical power density in general laser processing systems causes great changes in temperature distribution, which may cause irregularities in tin melting and affect molding, etc.

### SUMMARY

The disclosure provides a laser processing system capable of making effective use of laser speckle.

According to one embodiment of the disclosure, a laser processing system is configured to provide a processing beam. The laser processing system includes a laser, a beam splitting module, a first adjustment module, and a second adjustment module. The laser is configured to provide a laser beam. The beam splitting module is configured to split the laser beam into a first laser beam and a second laser beam. The first adjustment module is disposed on a transmission path of the first laser beam and configured to adjust the first laser beam to a central portion of the processing beam. The second adjustment module is disposed on a transmission path of the second laser beam and configured to adjust the second laser beam to an outer ring portion of the processing beam.

In one embodiment of the disclosure, the first adjustment module is further configured to transmit the central portion of the processing beam to the beam splitting module, the second adjustment module is further configured to transmit the outer ring portion of the processing beam to the beam splitting module, and the beam splitting module is further configured to combine the central portion and the outer ring portion of the processing beam.

In one embodiment of the disclosure, the beam splitting module includes a beam splitter or a polarization beam splitter.

In one embodiment of the disclosure, the first adjustment module includes at least one of a first light intensity adjustment module, a focusing module, and a first beam shaping module.

In one embodiment of the disclosure, the first light intensity adjustment module includes at least one of an absorptive polarizer, a quarter-wave plate, a half-wave plate, and a power attenuator.

In one embodiment of the disclosure, the focusing module includes a mirror and at least one lens.

In one embodiment of the disclosure, the first beam shaping module includes a combination of a beam shaping mask and a laser absorber or a spatial light modulator (SLM).

In one embodiment of the disclosure, the second adjustment module includes a second light intensity adjustment module and a second beam shaping module.

In one embodiment of the disclosure, the second light intensity adjustment module includes at least one of an absorptive polarizer, a quarter-wave plate, a half-wave plate, and a power attenuator.

In one embodiment of the disclosure, the second beam shaping module includes a combination of a beam shaping mask and a laser absorber, a combination of a beam shaping mask and a mirror, a combination of an axicon lens and a mirror, or a spatial light modulator.

In one embodiment of the disclosure, the laser processing system further includes a beam combiner. The beam combiner is disposed on a transmission path of the central portion of the processing beam from the first adjustment module and the outer ring portion of the processing beam from the second adjustment module, and is configured to combine the central portion and the outer ring portion of the processing beam.

In one embodiment of the disclosure, the laser processing system further includes a focusing module. The focusing module is disposed between the laser and the beam splitting module.

According to one embodiment of the disclosure, a laser processing system is configured to provide a processing beam. The laser processing system includes a first laser, a second laser, a first adjustment module, and a second adjustment module. The first laser is configured to provide a first laser beam. The second laser is configured to provide a second laser beam. The first adjustment module is disposed on a transmission path of the first laser beam and configured to adjust the first laser beam to a central portion of the processing beam. The second adjustment module is disposed on a transmission path of the second laser beam and configured to adjust the second laser beam to an outer ring portion of the processing beam.

In one embodiment of the disclosure, the first adjustment module includes at least one of a first light intensity adjustment module, a focusing module, and a first beam shaping module.

In one embodiment of the disclosure, the first light intensity adjustment module includes at least one of an absorptive polarizer, a quarter-wave plate, a half-wave plate, and a power attenuator.

In one embodiment of the disclosure, the focusing module includes a mirror and at least one lens.

In one embodiment of the disclosure, the first beam shaping module includes a combination of a beam shaping mask and a laser absorber or a spatial light modulator (SLM).

In one embodiment of the disclosure, the second adjustment module includes a second light intensity adjustment module and a second beam shaping module.

In one embodiment of the disclosure, the second light intensity adjustment module includes at least one of an absorptive polarizer, a quarter-wave plate, a half-wave plate, and a power attenuator.

In one embodiment of the disclosure, the second beam shaping module includes a combination of a beam shaping mask and a laser absorber, a combination of a beam shaping mask and a mirror, a combination of an axicon lens and a mirror, or a spatial light modulator.

Based on the above, in the embodiment of the disclosure, the laser beam is split into the first laser beam and the second laser beam through the beam splitting module, and then the first laser beam and the second laser beam are respectively shaped or energy adjusted, so that design parameters (e.g., shape, size or energy) of the speckle may be adjusted regionally according to the properties of a processing region.

To make the aforementioned more comprehensible, several accompanied with drawings are described in detail as follows.

### BRIEF DESCRIPTION OF THE DRAWING

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic flowchart of a laser processing system according to an embodiment of the disclosure.

FIG. 2A to FIG. 2D are respectively laser speckles of different embodiments of the disclosure.

FIG. 3, FIG. 6, FIG. 7, FIG. 9 and FIG. 10 are schematic views of a laser processing system according to a first embodiment to a fifth embodiment of the disclosure, respectively.

FIG. 4A to FIG. 4D are schematic top views of different implementation states of a beam shaping mask in FIG. 3, respectively.

FIG. 5 is a schematic top view of a beam shaping mask wheel applicable to the laser processing system of the disclosure.

FIG. 8A to FIG. 8D are schematic top views of different implementation states of a beam shaping mask in FIG. 7, respectively.

### DESCRIPTION OF THE EMBODIMENTS

Directional terms mentioned herein, such as “up”, “down”, “front”, “rear”, “left”, and “right”, only refer to the directions of the drawings. Accordingly, the directional terms used are for illustrative purposes and are not intended to limit the disclosure.

In the drawings, each drawing illustrates the general features of methods, structures or materials used in particular embodiments. However, these drawings should not be construed as defining or limiting the scope or nature covered by these embodiments. For example, relative sizes, thicknesses and positions of each film layer, region or structure may be reduced or enlarged for clarity.

In the following embodiments, the same or similar elements will be given the same or similar reference numerals, and the detailed description thereof will be omitted. In addition, the features in different embodiments may be combined with each other without conflict, and simple equivalent changes and modifications made according to the specification or the claims are still within the scope of this application.

Terms such as “first” and “second” mentioned in this specification or the claims are only used to name different elements or to distinguish different embodiments or ranges, and are not used to limit the upper or lower limit of the number of elements, nor are they used to limit the order of manufacture or the order of disposition of elements. Furthermore, the disposition of an element/film layer on (or over) another element/film layer may cover the situation where the element/film layer is disposed directly on (or over) the another element/film layer, and the two elements/ film layers are in direct contact; and where the element/film layer is indirectly disposed on (or above) the another element/film layer, and one or more elements/film layers exist between the two elements/film layers.

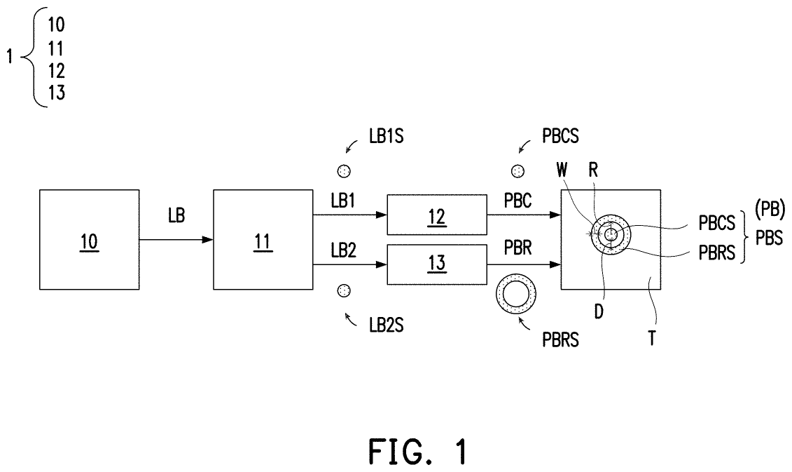

FIG. 1 is a schematic flowchart of a laser processing system according to an embodiment of the disclosure. Referring to FIG. 1, a laser processing system 1 may be configured to provide a processing beam PB to a processed object T. For example, the laser processing system 1 may perform precision processing on any tiny, heat-sensitive or high heat-capacity parts, such as precision soldering, but not limited thereto.

The laser processing system 1 may include a laser 10, a beam splitting module 11, a first adjustment module 12, and a second adjustment module 13. The laser 10 is configured to provide a laser beam LB. The beam splitting module 11 is configured to split the laser beam LB into a first laser beam LB1 and a second laser beam LB2. The first adjustment module 12 is disposed on a transmission path of the first laser beam LB1 and configured to adjust the first laser beam LB1 to a central portion PBC of the processing beam PB. The second adjustment module 13 is disposed on a transmission path of the second laser beam LB2 and configured to adjust the second laser beam LB2 to an outer ring portion PBR of the processing beam PB.

In detail, the beam splitting module 11 may include a beam splitter, a polarization beam splitter, or any element capable of splitting one beam into multiple (e.g., two) beams. The laser beam LB from the laser 10 is split into the first laser beam LB1 and the second laser beam LB2 through the beam splitting module 11. The first laser beam LB1 and the second laser beam LB2 may have the same or different light intensities. In addition, a speckle LB1S of the first laser beam LB1 and a speckle LB2S of the second laser beam LB2 may have the same shape (e.g., both are round) and the same or similar size. The shape and size of the speckle may be obtained by disposing white paper or other imaging elements perpendicular to a direction of light transmission on the transmission path of the laser beam.

According to different design/product requirements, at least one of the shape, size and light intensity of the speckle LB1S of the first laser beam LB1 from the beam splitting module 11 may be adjusted through the first adjustment module 12, and at least one of the shape, size and light intensity of the speckle LB2S of the second laser beam LB2 from the beam splitting module 11 may be adjusted through the second adjustment module 13, so that a laser speckle PBS projected onto the processed object T may meet the requirements.

Take laser soldering as an example, in order to control the temperature of component pins and pads respectively, and to improve the flow of tin and production yield, the laser speckle PBS used for processing may be designed to include an inner speckle PBCS for illuminating the component pins to control the temperature of the component pins and an outer speckle PBRS for illuminating the pads to control the temperature of the pads. The shape, size, and light intensity of the inner speckle PBCS may be adjusted by the first adjustment module 12 (e.g., by changing at least one of the shape, size, and light intensity of the speckle LB1S of the first laser beam LB1 to form the desired inner speckle PBCS). The shape, size (e.g. an inner diameter R, a ring width W, and other parameters) and light intensity of the outer speckle PBRS may be adjusted by the second adjustment module 13 (e.g. by changing at least one of the shape, size and light intensity of the speckle LB2S of the second laser beam LB2 to form the desired outer speckle PBRS).

The laser beam LB is split into the first laser beam LB1 and the second laser beam LB2 through the beam splitting module 11, and then the first laser beam LB1 and the second laser beam LB2 are respectively shaped or energy adjusted, so that design parameters (e.g., shape, size or energy) of the speckle (e.g. the inner speckle PBCS and the outer speckle PBRS) may be adjusted regionally and optimized according to the properties of a processing region, thereby being able to meet the requirements of various products (e.g. PCB). For example, optical power density of the inner speckle PBCS and the outer speckle PBRS may be adjusted respectively to optimize the temperature response, so that the soldering process may be smooth and increase the yield. In addition, by adjusting the size of the inner speckle PBCS and the outer speckle PBRS, a distance D between the inner speckle PBCS and the outer speckle PBRS may be adjusted to correspond to the size of a gap between the component pins and the pads, thus reducing the energy waste and component thermal damage caused by the laser light irradiating at the gap.

In FIG. 1, the inner speckle PBCS in the laser speckle PBS is located in the center of the laser speckle PBS, while the outer speckle PBRS in the laser speckle PBS is located outside the laser speckle PBS and surrounds the inner speckle PBCS. The shape of the inner speckle PBCS is round, and the shape of the outer speckle PBRS is a circular ring. However, it should be understood that the shapes of the inner speckle PBCS and outer speckle PBRS of the laser speckle PBS may be changed according to different requirements, not limited to those shown in FIG. 1.

In other embodiments, although not shown, the laser processing system 1 may include two lasers 10 (e.g., referred to as a first laser and a second laser). The first laser is configured to provide a first laser beam (e.g., the first laser beam LB1) to the first adjustment module 12, and the second laser is configured to provide a second laser beam (e.g., the second laser beam LB2) to the second adjustment module 13. The first adjustment module 12 may be configured to change at least one of the shape, size and light intensity of the speckle LB1S of the first laser beam LB1 to form the desired inner speckle PBCS, while the second adjustment module 13 may be configured to change at least one of the shape, size and light intensity of the speckle LB2S of the second laser beam LB2 to form the desired outer speckle PBRS.

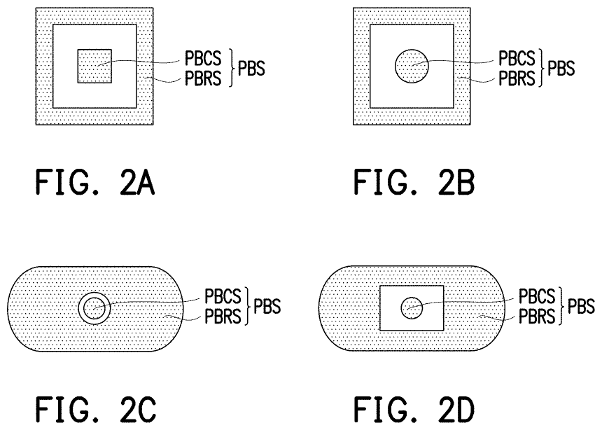

FIG. 2A to FIG. 2D are respectively laser speckles of different embodiments of the disclosure. In some embodiments, as shown in FIG. 2A, the shape of the inner speckle PBCS in the laser speckle PBS may be a quadrangle, and the outer speckle PBRS may be in the shape of a square frame. In other embodiments, as shown in FIG. 2B, the shape of the inner speckle PBCS in the laser speckle PBS may be round, and the outer speckle PBRS may be in the shape of a square frame. In some further embodiments, as shown in FIG. 2C, the shape of the inner speckle PBCS in the laser speckle PBS may be round, and the outer speckle PBRS may be in the shape of an oval frame. In still other embodiments, as shown in FIG. 2D, the shape of the inner speckle PBCS in the laser speckle PBS may be round, the outer edge shape of the outer speckle PBRS may be an ellipse or a quadrilateral, and the inner edge shape may be a quadrilateral. It should be understood that other shapes of the laser speckle PBS also fall within the scope outlined in the disclosure.

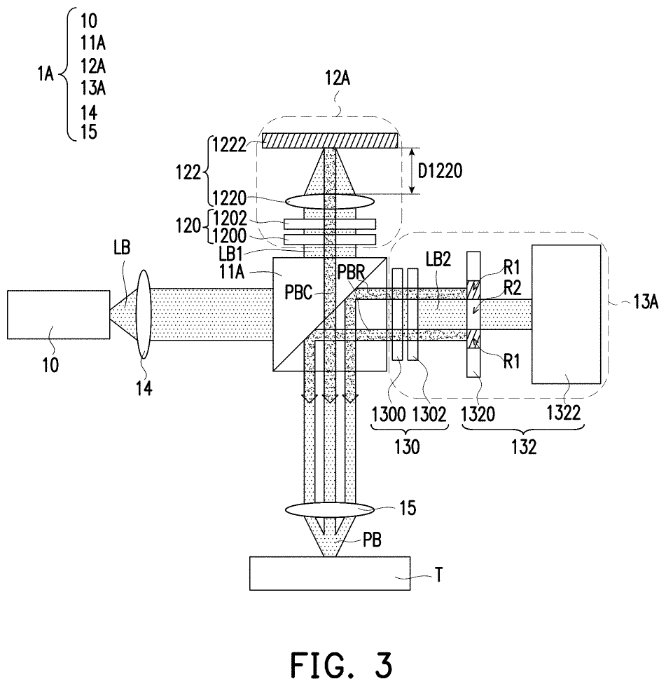

FIG. 3 is a schematic view of a laser processing system according to a first embodiment of the disclosure. Referring to FIG. 3, a laser processing system 1A includes, for example, a laser 10, a beam splitting module 11A, a first adjustment module 12A, a second adjustment module 13A, a collimating mirror 14, and a lens 15, but not limited thereto. According to different requirements, the laser processing system 1A may add or remove one or more elements.

The collimating mirror 14 is disposed between the laser 10 and the beam splitting module 11A, and the collimating mirror 14 may be configured to collimate a laser beam LB from the laser 10. In other embodiments, the collimating lens 14 may be replaced with a focusing module (not shown in FIG. 3, please refer to a focusing module 16 shown in FIG. 7). The following embodiments can be changed in the same way, and will not be repeated below.

The beam splitting module 11A is disposed on a transmission path of a collimated laser beam LB and splits the collimated laser beam LB into a first laser beam LB1 and a second laser beam LB2. In this embodiment, the beam splitting module 11A includes, for example, a beam splitter. The first laser beam LB1 and the second laser beam LB2 are respectively emitted from adjacent two sides of the beam splitter. In other embodiments, the beam splitting module 11A may include a polarization beam splitter or other element capable of splitting one beam into multiple (e.g., two) beams.

The first adjustment module 12A is disposed on a transmission path of the first laser beam LB1 from the beam splitting module 11A. In this embodiment, the first adjustment module 12A includes, for example, a first light intensity adjustment module 120 and a focusing module 122. However, the types of elements of the first adjustment module 12A are not limited thereto, and in other embodiments, the first adjustment module 12A may include at least one of the first light intensity adjustment module, the focusing module, and the first beam shaping module.

The first light intensity adjustment module 120 is, for example, disposed between the beam splitting module 11A and the focusing module 122, and the first light intensity adjustment module 120 may be configured to change the light intensity. In this embodiment, the first light intensity adjustment module 120 includes an absorptive polarizer 1200 and a quarter-wave plate 1202, and the absorptive polarizer 1200 is disposed between the beam splitting module 11A and the quarter-wave plate 1202. However, the types of elements of the first light intensity adjustment module 120 are not limited thereto, and in other embodiments, the first light intensity adjustment module 120 may include a quarter-wave plate, a polarizer, or a power attenuator.

The focusing module 122 is disposed on a transmission path of the first laser beam LB1 from the first light intensity adjustment module 120, and the focusing module 122 may be configured to change the size of the speckle. In this embodiment, the focusing module 122 includes a lens 1220 and a mirror 1222, and the lens 1220 is disposed between the first light intensity adjustment module 120 and the mirror 1222. It is possible to focus by changing a distance D1220 between the lens 1220 and the mirror 1222. However, the type or number of elements of the focusing module 122 is not limited thereto, and in other embodiments, the focusing module 122 may include multiple lenses, and the multiple lenses may be a combination of convex lenses and concave lenses.

In this embodiment, the mirror 1222 of the focusing module 122 reflects a central portion PBC of a processing beam PB, and the reflected central portion PBC passes through the lens 1220, the quarter-wave plate 1202, and the absorptive polarizer 1200 in sequence to the beam splitting module 11A. That is, the first adjustment module 12A not only adjusts the first laser beam LB1 to the central portion PBC of the processing beam PB (i.e., the central portion PBC of the processing beam PB is formed by changing the shape, size, or energy, etc. of the first laser beam LB1), but also transfers the central portion PBC of the processing beam PB to the beam splitting module 11A.

The second adjustment module 13A is disposed on a transmission path of the second laser beam LB2 from the beam splitting module 11A. In this embodiment, the second adjustment module 13A includes, for example, a second light intensity adjustment module 130 and a second beam shaping module 132. However, the types of elements of the second adjustment module 13A are not limited thereto.

The second light intensity adjustment module 130 is, for example, disposed between the beam splitting module 11A and the second beam shaping module 132, and the second light intensity adjustment module 130 may be configured to change the light intensity. In this embodiment, the second light intensity adjustment module 130 includes an absorptive polarizer 1300 and a quarter-wave plate 1302, and the absorptive polarizer 1300 is disposed between the beam splitting module 11A and the quarter-wave plate 1302. However, the types of elements of the second light intensity adjustment module 130 are not limited thereto, and in other embodiments, the second light intensity adjustment module 130 may include a quarter-wave plate, a polarizer, or a power attenuator.

The second beam shaping module 132 is disposed on a transmission path of the second laser beam LB2 from the second light intensity adjustment module 130, and the second beam shaping module 132 may be configured to change the shape and size of the speckle, such as controlling the shape, inner diameter, ring width, and other parameters of the outer speckle. In this embodiment, the second beam shaping module 132 includes a combination of a beam shaping mask 1320 and a laser absorber 1322, and the beam shaping mask 1320 is disposed between the second light intensity adjustment module 130 and the laser absorber 1322. However, the type or number of elements of the second beam shaping module 132 is not limited thereto. In other embodiments, the second beam shaping module 132 may include a combination of a beam shaping mask and a mirror, a combination of an axicon lens and a mirror, or a spatial light modulator.

In this embodiment, the beam shaping mask 1320 is, for example, a reflective mask, and the beam shaping mask 1320 includes a reflective region R1 and a light transmission region R2. The second laser beam LB2 transmitted to the light transmission region R2 of the beam shaping mask 1320 passes through the light transmission region R2 and is absorbed by the laser absorber 1322, while the second laser beam LB2 transmitted to the reflective region R1 of the beam shaping mask 1320 is reflected by the reflective region R1 and transmitted to the beam splitting module 11A by passing through the quarter-wave plate 1302 and the absorptive polarizer 1300 in sequence. That is, the second adjustment module 13A not only adjusts the second laser beam LB2 to an outer ring portion PBR of the processing beam PB (i.e., the outer ring portion PBR of the processing beam PB is formed by changing the shape, size, or energy, etc. of the second laser beam LB2), but also transfers the outer ring portion PBR of the processing beam PB to the beam splitting module 11A.

In this embodiment, the beam splitting module 11A is also disposed on a transmission path of the central portion PBC of the processing beam PB from the first adjustment module 12A and the outer ring portion PBR of the processing beam PB from the second adjustment module 13A, and configured to combine the central portion PBC and the outer ring portion PBR of the processing beam PB.

The lens 15 is disposed on a transmission path of the central portion PBC and the outer ring portion PBR of the combined processing beam PB and converges the processing beam PB to a processed object T.

In this embodiment, the first adjustment module 12A is, for example, an inner speckle adjustment module. The light intensity of the inner speckle projected onto the processed object T may be adjusted through the first light intensity adjustment module 120 in the first adjustment module 12A, and the size of the inner speckle projected onto the processed object T may be adjusted through the focusing module 122 in the first adjustment module 12A. In addition, the second adjustment module 13A is, for example, an outer speckle adjustment module. The light intensity of the outer speckle projected on the processed object T may be adjusted through the second light intensity adjustment module 130 in the second adjustment module 13A, and the parameters such as the inner diameter and ring width of the outer speckle projected onto the processed object T may be adjusted by the second beam shaping module 132 in the second adjustment module 13A. By individually changing the speckle parameters (e.g., light intensity, shape, or size, etc.) to individually heat the pads and pins on the solder joint, the temperature difference may be simultaneously reduced and the efficiency of melting tin may be improved.

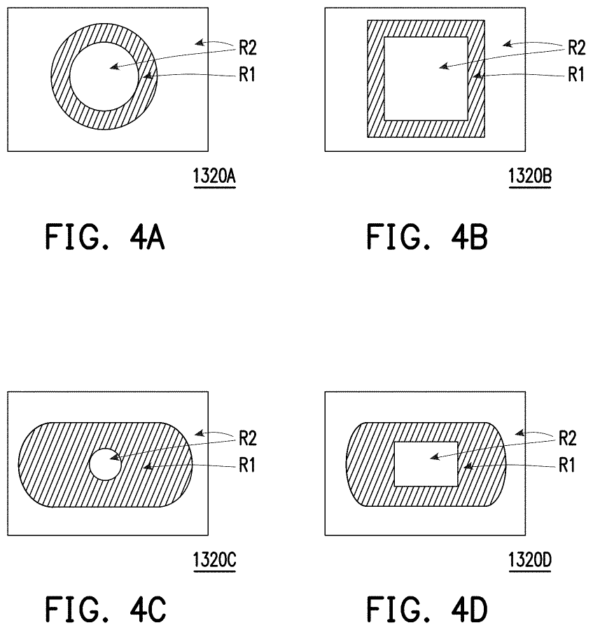

FIG. 4A to FIG. 4D are schematic top views of different implementation states of the beam shaping mask 1320 in FIG. 3, respectively. As shown in FIG. 4A to FIG. 4D, the reflective region R1 and the light transmission region R2 of the beam shaping mask may be designed according to the desired shape and size of the outer speckle. For example, a beam shaping mask 1320A shown in FIG. 4A may be configured to form the circular shaped outer speckle PBRS as shown in FIG. 1. Alternatively, a beam shaping mask 1320B as shown in FIG. 4B may be configured to form the square frame-shaped outer speckle PBRS as shown in FIG. 2A or 2B. Alternatively, a beam shaping mask 1320C as shown in FIG. 4C may be configured to form the elliptical frame-shaped outer speckle PBRS as shown in FIG. 2C. Furthermore, a beam shaping mask 1320D as shown in FIG. 4D may be configured to form the elliptical frame-shaped outer speckle PBRS with a quadrangular inner edge as shown in FIG. 2D.

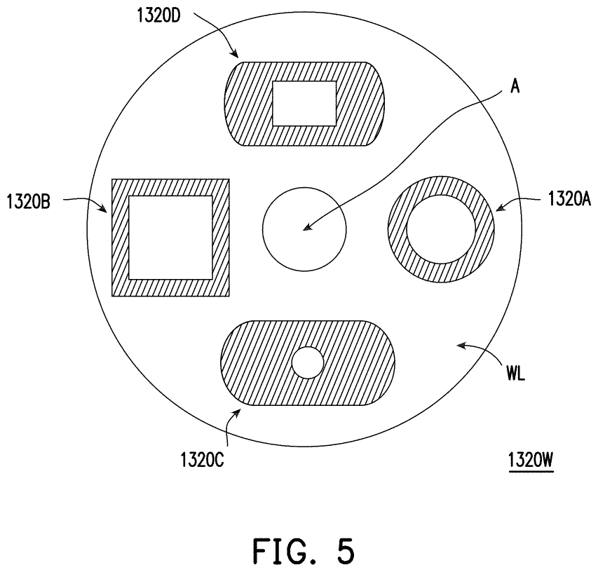

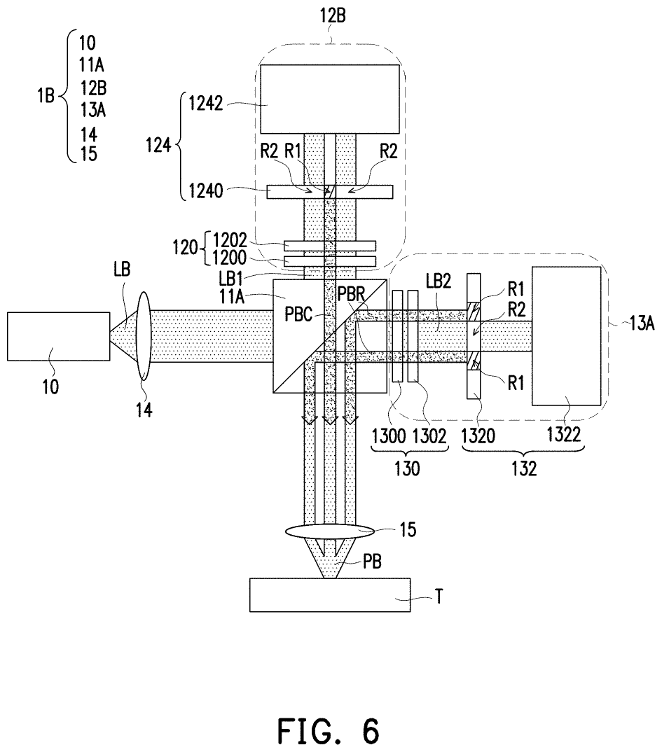

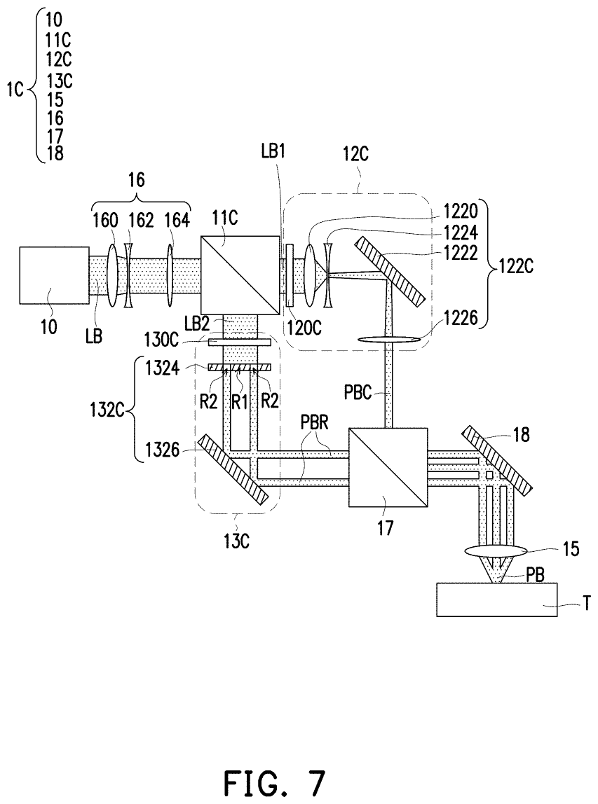

FIG. 5 is a schematic top view of a beam shaping mask wheel applicable to the laser processing system of the disclosure. In some embodiments, the beam shaping mask 1320 in FIG. 3 may be replaced with a beam shaping mask wheel 1320W as shown in FIG. 5. The beam shaping mask wheel 1320W may include a wheel WL. The wheel WL may be formed with the beam shaping mask 1320A to the beam shaping mask 1320D as shown in FIG. 4A to FIG. 4D. The beam shaping mask 1320A to the beam shaping mask 1320D are arranged around an axis A of the wheel WL and may be arranged along the circumference of the wheel WL. In practice, the beam shaping mask wheel 1320W may be rotated according to the desired outer speckle shape so that the corresponding beam shaping mask cuts into the transmission path of the second laser beam LB2 from the second light intensity adjustment module 130 in FIG. 3. That is, the outer speckle shape may be changed by rotating the beam shaping mask wheel 1320W instead of changing the outer speckle shape by replacing the beam shaping mask 1320, which further enhances the operational convenience and/or saves operational time.

FIG. 6 is a schematic view of a laser processing system according to a second embodiment of the disclosure. Referring to FIG. 6, the main differences between a laser processing system 1B and the laser processing system 1A of FIG. 3 are explained as follows.

In the laser processing system 1B, a first adjustment module 12B includes a first light intensity adjustment module 120 and a first beam shaping module 124, and the first light intensity adjustment module 120 is disposed between a beam splitting module 11A and the first beam shaping module 124.

In this embodiment, the first beam shaping module 124 includes a combination of a beam shaping mask 1240 and a laser absorber 1242. However, the types of elements of the first beam shaping module 124 are not limited thereto. In other embodiments, the first beam shaping module 124 may include a spatial light modulator.

In this embodiment, the beam shaping mask 1240 is, for example, a reflective mask, and the beam shaping mask 1240 includes a reflective region R1 and a light transmission region R2. The first laser beam LB1 transmitted to the light transmission region R2 of the beam shaping mask 1241 passes through the light transmission region R2 and is absorbed by the laser absorber 1242, while the first laser beam LB1 transmitted to the reflective region R1 of the beam shaping mask 1240 is reflected by the reflective region R1 and transmitted to the beam splitting module 11A by passing through the quarter-wave plate 1202 and the absorptive polarizer 1200 in sequence. That is, the first adjustment module 12B not only adjusts the first laser beam LB1 to the central portion PBC of the processing beam PB (i.e., the central portion PBC of the processing beam PB is formed by changing the shape, size, or energy, etc. of the first laser beam LB1), but also transfers the central portion PBC of the processing beam PB to the beam splitting module 11A.

The relative arrangement of the reflective region R1 and the light transmission region R2 of the beam shaping mask 1240 may be designed according to the desired shape and size of the inner speckle. For example, the reflective region R1 of the beam shaping mask 1240 may be circular to form a circular inner speckle PBCS as shown in FIG. 1, FIG. 2B, FIG. 2C or FIG. 2D; alternatively, the reflective region R1 of the beam shaping mask 1240 may be a quadrilateral to form a quadrilateral inner speckle PBCS as shown in FIG. 2A, but not limited thereto. In other embodiments, the shape of the inner speckle PBCS can also be other polygons.

In this embodiment, the first adjustment module 12B is, for example, an inner speckle adjustment module. The light intensity of the inner speckle projected onto the processed object T may be adjusted through the first light intensity adjustment module 120 in the first adjustment module 12B, and the shape and/or size of the inner speckle projected onto the processed object T may be adjusted through the first beam shaping module 124 in the first adjustment module 12B. In addition, the second adjustment module 13A is, for example, an outer speckle adjustment module. The light intensity of the outer speckle projected on the processed object T may be adjusted through the second light intensity adjustment module 130 in the second adjustment module 13A, and the parameters such as the inner diameter and ring width of the outer speckle projected onto the processed object T may be adjusted by the second beam shaping module 132 in the second adjustment module 13A. By individually changing the speckle parameters (e.g., light intensity, shape, or size, etc.) to individually heat the pads and pins on the solder joint, the temperature difference may be simultaneously reduced and the efficiency of melting tin may be improved.

FIG. 7 is a schematic view of a laser processing system according to a third embodiment of the disclosure. Referring to FIG. 7, the main differences between the laser processing system 1C and the laser processing system 1A of FIG. 3 are explained as follows.

The laser processing system 1C includes, for example, a laser 10, a beam splitting module 11C, a first adjustment module 12C, a second adjustment module 13C, a lens 15, a focusing module 16, a beam combiner 17 and a mirror 18, but is not limited thereto. According to different requirements, the laser processing system 1C may add or remove one or more elements.

The focusing module 16 is disposed between the laser 10 and the beam splitting module 11C. The focusing module 16 includes, for example, a lens 160, a lens 162, and a lens 164 arranged in sequence along a transmission path of the laser beam LB, and may focus by changing the spacing on the optical axis between any adjacent two of the lenses 160, 162, and 164. In this embodiment, the lens 160, the lens 162, and the lens 164 are respectively a convex lens, a concave lens, and a convex lens, but not limited thereto. The design parameters such as refractive power, radius of curvature and/or refractive index of each lens may be changed according to different requirements without restriction.

The beam splitting module 11C is disposed on a transmission path of the laser beam LB from the focusing module 16, and the laser beam LB is split into a first laser beam LB1 and a second laser beam LB2. In this embodiment, the beam splitting module 11C includes a polarization beam splitter. The first laser beam LB1 and the second laser beam LB2 are respectively emitted from adjacent two sides of the polarization beam splitter. In other embodiments, the beam splitting module 11C may include a beam splitter or other element capable of splitting one beam into multiple (e.g., two) beams.

The first adjustment module 12C is disposed on a transmission path of the first laser beam LB1 from the beam splitting module 11C. In this embodiment, the first adjustment module 12C includes, for example, a first light intensity adjustment module 120C and a focusing module 122C. However, the types of elements of the first adjustment module 12C are not limited thereto, and in other embodiments, the first adjustment module 12C may include at least one of the first light intensity adjustment module, the focusing module, and the first beam shaping module.

The first light intensity adjustment module 120C is, for example, disposed between the beam splitting module 11C and the focusing module 122C, and the first light intensity adjustment module 120C may be configured to change the light intensity. In this embodiment, the first light intensity adjustment module 120C includes a half-wave plate. However, the types of elements of the first light intensity adjustment module 120C are not limited thereto, and in other embodiments, the first light intensity adjustment module 120C may include at least one of an absorptive polarizer, a quarter-wave plate, a half-wave plate, or a power attenuator.

The focusing module 122C is disposed on a transmission path of the first laser beam LB1 from the first light intensity adjustment module 120C, and the focusing module 122C may be configured to change the size of the speckle. In this embodiment, the focusing module 122C includes a lens 1220, a mirror 1222, a lens 1224, and a lens 1226. The lens 1220 is disposed between the first light intensity adjustment module 120C and the mirror 1222, the lens 1224 is disposed between the lens 1220 and the mirror 1222, and the mirror 1222 is disposed between the lens 1224 and the lens 1226. The lens 1220, the lens 1224, and the lens 1226 are, for example, a convex lens, a concave lens, and a convex lens, respectively, but not limited thereto. The design parameters such as refractive power, radius of curvature and/or refractive index of each lens may be changed according to different requirements without restriction. It is possible to focus by changing the distance between two adjacent elements in the focusing module 122C. However, the type or number of elements of the focusing module 122C is not limited thereto, and in other embodiments, the focusing module 122C may include fewer or more lenses.

In this embodiment, the first laser beam LB1 is sequentially adjusted to the central portion PBC of the processing beam PB through the first light intensity adjustment module 120C and the focusing module 122C, and is transmitted to the beam combiner 17 by the focusing module 122C. That is, the first adjustment module 12C not only adjusts the first laser beam LB1 to the central portion PBC of the processing beam PB, but also transfers the central portion PBC of the processing beam PB to the beam combiner 17.

The second adjustment module 13C is disposed on a transmission path of the second laser beam LB2 from the beam splitting module 11C. In this embodiment, the second adjustment module 13C includes, for example, a second light intensity adjustment module 130C and a second beam shaping module 132C. However, the types of elements of the second adjustment module 13C are not limited thereto.

The second light intensity adjustment module 130C is, for example, disposed between the beam splitting module 11C and the second beam shaping module 132C, and the second light intensity adjustment module 130C may be configured to change the light intensity. In this embodiment, the second light intensity adjustment module 130C includes a half-wave plate. However, the types of elements of the second light intensity adjustment module 130C are not limited thereto. In other embodiments, the second light intensity adjustment module 130C may include at least one of an absorptive polarizer, a quarter-wave plate, a half-wave plate, and a power attenuator.

The second beam shaping module 132C is disposed on a transmission path of the second laser beam LB2 from the second light intensity adjustment module 130C, and the second beam shaping module 132C may be configured to change the shape and size of the speckle, such as controlling the shape, inner diameter, ring width, and other parameters of the outer speckle. In this embodiment, the second beam shaping module 132C includes a combination of a beam shaping mask 1324 and a mirror 1326, and the beam shaping mask 1324 is disposed between the second light intensity adjustment module 130C and the mirror 1326. However, the type or number of elements of the second beam shaping module 132C is not limited thereto. In other embodiments, the second beam shaping module 132C may include a combination of a beam shaping mask and a laser absorber, a combination of an axicon lens and a mirror, or a spatial light modulator.

In this embodiment, the beam shaping mask 1324 is, for example, a light transmission mask, and the beam shaping mask 1324 includes a reflective region R1 and a light transmission region R2. The second laser beam LB2 transmitted to the reflective region R1 of the beam shaping mask 1324 is reflected by the reflective region R1 back to the second light intensity adjustment module 130C, while the second laser beam LB2 transmitted to the light transmission region R2 of the beam shaping mask 1320 passes through the light transmission region R2 and is then reflected by the mirror 1326 and transmitted to the beam combiner 17. That is to say, the second adjustment module 13C not only adjusts the second laser beam LB2 to the outer ring portion PBR of the processing beam PB, but also transfers the outer ring portion PBR of the processing beam PB to the beam combiner 17.

The beam combiner 17 is disposed on a transmission path of the central portion PBC of the processing beam PB from the first adjustment module 12C and the outer ring portion PBR of the processing beam PB from the second adjustment module 13C, and is configured to combine the central portion PBC and outer ring portion PBR of the processing beam PB. In this embodiment, the beam combiner 17 is, for example, a polarization splitting element or a power splitting element, but not limited thereto.

The mirror 18 is disposed on a transmission path of the central portion PBC and the outer ring portion PBR of the combined processing beam PB and reflects the processing beam PB to the lens 15.

The lens 15 is disposed on a transmission path of a reflected processing beam PB and converges the processing beam PB to the processed object T.

In this embodiment, the first adjustment module 12C is, for example, an inner speckle adjustment module. The light intensity of the inner speckle projected onto the processed object T may be adjusted through the first light intensity adjustment module 120C in the first adjustment module 12C, and the size of the inner speckle projected onto the processed object T may be adjusted through the focusing module 122C in the first adjustment module 12C. In addition, the second adjustment module 13C is, for example, an outer speckle adjustment module. The light intensity of the outer speckle projected on the processed object T may be adjusted through the second light intensity adjustment module 130C in the second adjustment module 13C, and the parameters such as the inner diameter and ring width of the outer speckle projected onto the processed object T may be adjusted by the second beam shaping module 132C in the second adjustment module 13C. By individually changing the speckle parameters (e.g., light intensity, shape, or size, etc.) to individually heat the pads and pins on the solder joint, the temperature difference may be simultaneously reduced and the efficiency of melting tin may be improved.

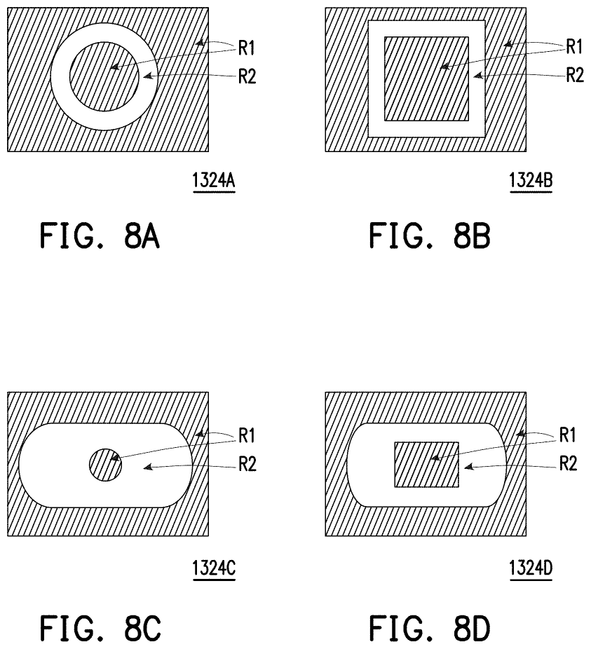

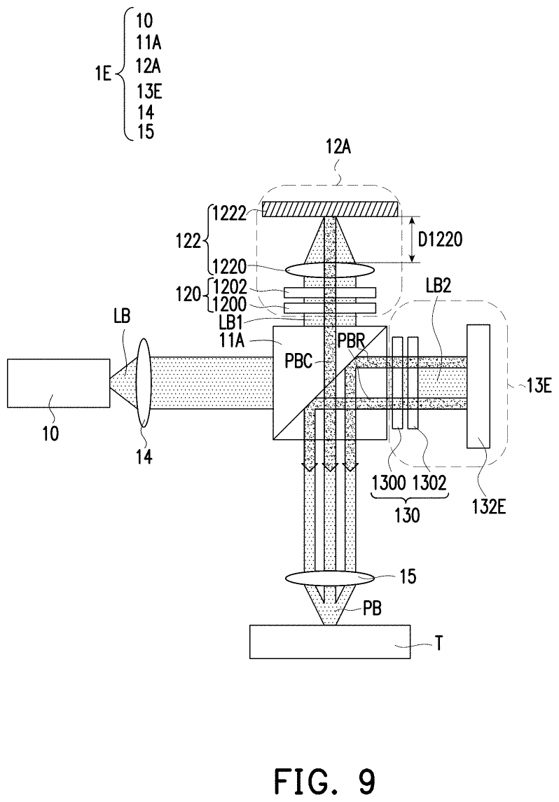

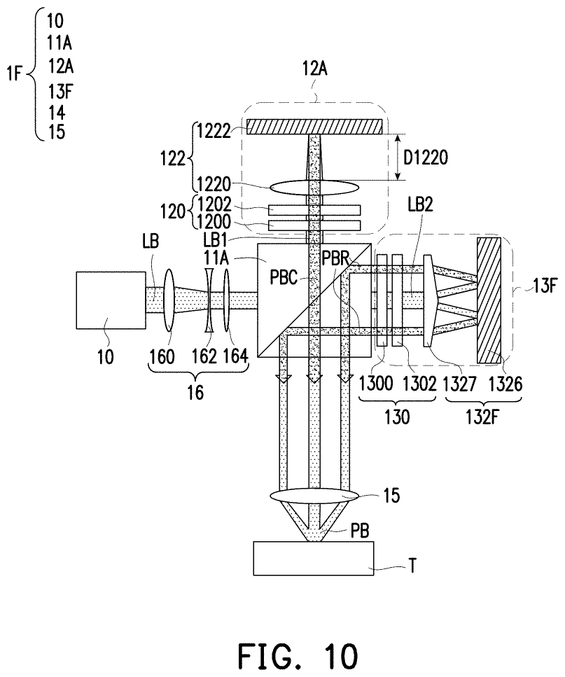

FIG. 8A to FIG. 8D are schematic top views of different implementation states of the beam shaping mask 1324 in FIG. 7, respectively. As shown in FIG. 8A to FIG. 8D, the reflective region R1 and the light transmission region R2 of the beam shaping mask may be designed according to the desired shape and size of the outer speckle. For example, a beam shaping mask 1324A shown in FIG. 8A may be configured to form the circular shaped outer speckle PBRS as shown in FIG. 1. Alternatively, a beam shaping mask 1324B as shown in FIG. 8B may be configured to form the square frame-shaped outer speckle PBRS as shown in FIG. 2A or 2B.

Alternatively, a beam shaping mask 1324C as shown in FIG. 8C may be configured to form the elliptical frame-shaped outer speckle PBRS as shown in FIG. 2C. Furthermore, a beam shaping mask 1324D as shown in FIG. 8D may be used to form the elliptical frame-shaped outer speckle PBRS with a quadrangular inner edge as shown in FIG. 2D.

In some embodiments, although not shown, the beam shaping mask 1324 in FIG. 7 may be replaced with the beam shaping mask wheel 1320W shown in FIG. 5. The wheel WL in the beam shaping mask wheel 1320W may be formed with the beam shaping mask 1324A to the beam shaping mask 1324D as shown in FIG. 8A to 8D. The beam shaping mask 1324A to the beam shaping mask 1324D are arranged around an axis A of the wheel WL and may be arranged along the circumference of the wheel WL. In practice, the beam shaping mask wheel 1320W may be rotated according to the desired outer speckle shape so that the corresponding beam shaping mask cuts into the transmission path of the second laser beam LB2 from the second light intensity adjustment module 130C in FIG. 7. That is, the outer speckle shape may be changed by rotating the beam shaping mask wheel 1320W instead of changing the outer speckle shape by replacing the beam shaping mask 1324, which further enhances the operational convenience and/or saves operational time.

FIG. 9 is a schematic view of a laser processing system according to a fourth embodiment of the disclosure. Referring to FIG. 9, the main differences between a laser processing system 1E and the laser processing system 1A of FIG. 3 are explained as follows.

In the laser processing system 1E, a second adjustment module 13E includes a second light intensity adjustment module 130 and a second beam shaping module 132E, and the second light intensity adjustment module 130 is disposed between a beam splitting module 11A and the second beam shaping module 132E.

In this embodiment, the second beam shaping module 132E includes a spatial light modulator, such as a reflective spatial light modulator, but is not limited thereto. The second beam shaping module 132E may, for example, perform speckle shaping by means of holography. For example, Gerchberg-Saxton algorithm may be used to design a hologram, and Fourier transform may be done through the lens 15 to diffract modulated light from the hologram into a ring-shaped speckle. The inner diameter and ring width of the outer speckle may be changed through the design of the hologram. It should be understood that the type of the spatial light modulator and the algorithm used to design the hologram may be changed according to the requirements, not limited to the above.

In this embodiment, the first adjustment module 12A is, for example, an inner speckle adjustment module. The light intensity of the inner speckle projected onto the processed object T may be adjusted through the first light intensity adjustment module 120A in the first adjustment module 12A, and the size of the inner speckle projected onto the processed object T may be adjusted through the focusing module 122 in the first adjustment module 12A. In addition, the second adjustment module 13E is, for example, an outer speckle adjustment module. The light intensity of the outer speckle projected on the processed object T may be adjusted through the second light intensity adjustment module 130 in the second adjustment module 13E, and the parameters such as the inner diameter and ring width of the outer speckle projected onto the processed object T may be adjusted by the second beam shaping module 132E in the second adjustment module 13E. By individually changing the speckle parameters (e.g., light intensity, shape, or size, etc.) to individually heat the pads and pins on the solder joint, the temperature difference may be simultaneously reduced and the efficiency of melting tin may be improved.

In other embodiments, although not shown, the focusing module 122 in the first adjustment module 12A may also be replaced with a spatial light modulator, and the first adjustment module 12A may adjust the shape or size, etc. of the inner speckle projected onto the processed object T by the spatial light modulator.

FIG. 10 is a schematic view of a laser processing system according to a fifth embodiment of the disclosure. Referring to FIG. 10, the main differences between a laser processing system 1F and the laser processing system 1E of FIG. 9 are described as follows.

In the laser processing system 1F, a second adjustment module 13F includes a second light intensity adjustment module 130 and a second beam shaping module 132F, and the second light intensity adjustment module 130 is disposed between the beam splitting module 11A and the second beam shaping module 132F.

In this embodiment, the second beam shaping module 132F includes a combination of an axicon lens 1327 and a mirror 1326, and the axicon lens 1327 is disposed between the second light intensity adjustment module 130 and the mirror 1326. The second laser beam LB2 from the beam splitting module 11A forms the outer ring portion PBR of the processing beam PB by the action of the second light intensity adjustment module 130, the axicon lens 1327, and the mirror 1326 in sequence, and the outer ring portion PBR of the processing beam PB is transmitted to the beam splitting module 11A by the reflection of the mirror 1326. That is, the second adjustment module 13F not only adjusts the second laser beam LB2 to the outer ring portion PBR of the processing beam PB, but also transfers the outer ring portion PBR of the processing beam PB to the beam splitting module 11A.

In this embodiment, the first adjustment module 12A is, for example, an inner speckle adjustment module. The light intensity of the inner speckle projected onto the processed object T may be adjusted through the first light intensity adjustment module 120 in the first adjustment module 12A, and the size of the inner speckle projected onto the processed object T may be adjusted through the focusing module 122 in the first adjustment module 12A. In addition, the second adjustment module 13F is, for example, an outer speckle adjustment module. The light intensity of the outer speckle projected on the processed object T may be adjusted through the second light intensity adjustment module 130 in the second adjustment module 13F, and the parameters such as the inner diameter and ring width of the outer speckle projected onto the processed object T may be adjusted by the second beam shaping module 132F in the second adjustment module 13F. By individually changing the speckle parameters (e.g., light intensity, shape, or size, etc.) to individually heat the pads and pins on the solder joint, the temperature difference may be simultaneously reduced and the efficiency of melting tin may be improved.

To sum up, in the embodiment of the disclosure, the laser beam is split into the first laser beam and the second laser beam through the beam splitting module, and then the first laser beam and the second laser beam are respectively shaped or energy adjusted, so that design parameters (e.g., shape, size or energy) of the speckle may be adjusted regionally according to the properties of a processing region. In some embodiments, the first adjustment module and the second adjustment module are an inner speckle adjustment module and an outer speckle adjustment module, respectively. By shaping and/or energy adjustment of the inner speckle and the outer speckle respectively, it helps to reduce the energy waste and component thermal damage caused by the laser light irradiating at the gap, and/or helps to reduce temperature difference and improve the efficiency of melting tin.

It will be apparent to those skilled in the art that various modifications and variations can be made to the disclosed without departing from the scope or spirit of the disclosure. In view of the foregoing, it is intended that the disclosure covers modifications and variations provided that they fall within the scope of the following claims and their equivalents.

What is claimed is:

1. A laser processing system configured to provide a processing beam and comprising:
a laser configured to provide a laser beam;
a beam splitting module configured to split the laser beam into a first laser beam and a second laser beam;
a first adjustment module disposed on a transmission path of the first laser beam and configured to adjust the first laser beam to a central portion of the processing beam; and
a second adjustment module disposed on a transmission path of the second laser beam and configured to adjust the second laser beam to an outer ring portion of the processing beam.

2. The laser processing system according to claim 2, wherein the first adjustment module is further configured to transmit the central portion of the processing beam to the beam splitting module, the second adjustment module is further configured to transmit the outer ring portion of the processing beam to the beam splitting module, and the beam splitting module is further configured to combine the central portion and the outer ring portion of the processing beam.

3. The laser processing system according to claim 1, wherein the beam splitting module comprises a beam splitter or a polarization beam splitter.

4. The laser processing system according to claim 1, wherein the first adjustment module comprises at least one of a first light intensity adjustment module, a focusing module, and a first beam shaping module.

5. The laser processing system according to claim 4, wherein the first light intensity adjustment module comprises at least one of an absorptive polarizer, a quarter-wave plate, a half-wave plate, and a power attenuator.

6. The laser processing system according to claim 4, wherein the focusing module comprises a mirror and at least one lens.

7. The laser processing system according to claim 4, wherein the first beam shaping module comprises a combination of a beam shaping mask and a laser absorber or a spatial light modulator.

8. The laser processing system according to claim 1, wherein the second adjustment module comprises a second light intensity adjustment module and a second beam shaping module.

9. The laser processing system according to claim 8, wherein the second light intensity adjustment module comprises at least one of an absorptive polarizer, a quarter-wave plate, a half-wave plate, and a power attenuator.

10. The laser processing system according to claim 8, wherein the second beam shaping module comprises a combination of a beam shaping mask and a laser absorber, a combination of a beam shaping mask and a mirror, a combination of an axicon lens and a mirror, or a spatial light modulator.

11. The laser processing system according to claim 1 further comprising:
a beam combiner disposed on a transmission path of the central portion of the processing beam from the first adjustment module and the outer ring portion of the processing beam from the second adjustment module, and configured to combine the central portion and the outer ring portion of the processing beam.

12. The laser processing system according to claim 1 further comprising:
a focusing module disposed between the laser and the beam splitting module.

13. A laser processing system configured to provide a processing beam and comprising:
a first laser configured to provide a first laser beam;
a second laser configured to provide a second laser beam;
a first adjustment module disposed on a transmission path of the first laser beam and configured to adjust the first laser beam to a central portion of the processing beam; and
a second adjustment module disposed on a transmission path of the second laser beam and configured to adjust the second laser beam to an outer ring portion of the processing beam.

14. The laser processing system according to claim 13, wherein the first adjustment module comprises at least one of a first light intensity adjustment module, a focusing module, and a first beam shaping module.

15. The laser processing system according to claim 14, wherein the first light intensity adjustment module comprises at least one of an absorptive polarizer, a quarter-wave plate, a half-wave plate, and a power attenuator.

16. The laser processing system according to claim 14, wherein the focusing module comprises a mirror and at least one lens.

17. The laser processing system according to claim 14, wherein the first beam shaping module comprises a combination of a beam shaping mask and a laser absorber or a spatial light modulator.

18. The laser processing system according to claim 13, wherein the second adjustment module comprises a second light intensity adjustment module and a second beam shaping module.

19. The laser processing system according to claim 18, wherein the second light intensity adjustment module comprises at least one of an absorptive polarizer, a quarter-wave plate, a half-wave plate, and a power attenuator.

20. The laser processing system according to claim 18, wherein the second beam shaping module comprises a combination of a beam shaping mask and a laser absorber, a combination of a beam shaping mask and a mirror, a combination of an axicon lens and a mirror, or a spatial light modulator.
